(19) United States
(12) Patent Application Publication
(10) Pub. No.: US 2016/0219906 A1
(43) Pub. Date: Aug. 4, 2016

(54) SYSTEM AND METHOD OF SHARING RECIPES FOR AN AUTOMATIC MEAL PREPARATION APPARATUS

(71) Applicant: Kitchen Mate Inc., Toronto (CA)

(72) Inventors: Yang YU, TORONTO (CA); Yousuf CHOWDHARY, MAPLE (CA)

(21) Appl. No.: 15/010,971

(22) Filed: Jan. 29, 2016

Related U.S. Application Data
(60) Provisional application No. 62/109,671, filed on Jan. 30, 2015.

(51) Int. Cl. A23L 1/01; G06F 17/30; G06Q 30/06

(52) U.S. Cl. CPC A23L 1/0128; G06F 17/30598; G06Q 30/0601; A23V 2002/00

(57) ABSTRACT

A method is provided for preparing a recipe with an automatic meal preparation apparatus. After a recipe is selected from a recipe database associated with the automatic meal preparation apparatus, the selected recipe is checked as a certified recipe for the automatic meal preparation apparatus. If certified, a user is directed to add prepared raw ingredients to a raw ingredients compartment in the user's apparatus. The presence of at least one spice/sauce cartridge needed for the recipe is checked. The apparatus then executes instructions of the recipe. These include heating, dispensing, and stirring and cooking steps. A method of sharing a recipe for an automatic meal preparation apparatus is also provided.

### REFERENCE TO RELATED APPLICATIONS

The present invention claims the benefit of priority to U.S. Provisional Patent Application Ser. No. 62/109,671 filed on Jan. 30, 2015, which is hereby incorporated herein by reference in its entirety.

### FIELD OF INVENTION

The invention relates to devices for automatic meal preparation and more particularly relates to methods of exchanging recipes for such devices.

### BACKGROUND

Enjoying a homemade meal is not always straightforward. It not only involves actually cooking the food, but also deciding what to cook, and knowing how to cook it. Often, this involves following recipes precisely, sourcing the right ingredients and spices, and adding the precise quantities at the right time so that each ingredient is cooked to perfection. Failing to follow the recipe may lead to undesirable outcomes. If everything is performed accordingly, a homemade meal is not only delicious, but also very nutritious. While cooking can be an enjoyable experience, in today's fast-paced world, it is often a rather tedious chore.

There are many good reasons to cook meals from scratch. Cooking simply at home from whole ingredients is often cheaper than even fast food restaurants. Food made at home usually has far less salt and fat than either processed food or ready to eat frozen meals.

Sharing recipes that are trusted and have stood the test of time is common. Such recipes still require that a user prepare the meal. Recipe books focused on many different types of cuisines are available—such as, cookbooks for Chinese stir fries, Indian curries, Mexican dishes, etc. Cookbooks are also available for different types of meals and delicacies—such as, cookbooks for seafood, desserts, sandwiches, soups, etc. People frequently share such books or individual recipes.

Books and paper-based recipe collections have evolved to the digital realm with recipe search engines like Foodily which is also considered a social recipe network. Similarly, apps for recipes also exist that can be installed on mobile devices like tablets or Smartphones, e.g. “Yummly Recipes”, “Food Network in the Kitchen”, “PetitChef” etc.

But neither cookbooks, recipe search engines, nor recipe apps are able to prepare the meals automatically. Meal preparation is still a very laborious and time consuming activity that also requires a certain skill set.

Multiple factors are impacting people's perception about cooking at home. Raw ingredients are more expensive than frozen dinners. It takes time and effort to buy the raw produce, imagine what to cook, determine the recipe to cook, and then actually cook it.

Many people are too busy and do not have the time or imagination to cook. They are hooked to the fast food restaurants that offer fast and cheap meals. People have lost the skills and will to cook healthy meals from scratch.

People are more accustomed to a wider selection of food options and have a more varied palate now than a few decades ago. When they cook at home, they expect to have a similar variety of diverse cuisines with exotic ingredients.

Making food quickly and well can be easy once one has mastered how to cook; but it is a learned skill, the acquisition of which takes time, practice, patience and the acceptance of mistakes. To cook whole foods at a pace that can match box-meal offerings, one needs to know how to make substitutions on the fly; how to doctor a dish that has been oversalted or overspiced; how to select produce and know how long one has to cook it for, amongst other variables.

Mistakes are a natural part of learning to cook, but they can cost a person time, ingredients, and money without actually feeding anyone. A botched recipe can make the expensive ingredients inedible. Too many mistakes can also make a persuasive case that cooking is not worth the trouble and that Hamburger Helper is worth the cost. Therefore without these skills, cooking from scratch becomes a risky business.

Slow cooker devices are known, which allow a person to assemble all the ingredients then just leave them to cook while they do other things. A slow cooker, also known as a Crock-Pot (a trademark), is a countertop electrical cooking appliance that is used for simmering, which requires maintaining a relatively low temperature (compared to other cooking methods such as baking, boiling, and frying), allowing unattended cooking for many hours of pot roasts, stews, soups and other suitable dishes, including dips, desserts and beverages. A basic slow cooker consists of a lidded round or oval cooking pot made of glazed ceramic or porcelain, surrounded by a housing usually made of metal, containing an electric heating element. The lid is often of glass seated in a groove in the pot edge.

A slow cooker is designed to cook while no one is there to care for it, thus allowing a cook to fill the pot with the required ingredients and come back several hours later to a ready meal. Raw food and a liquid (such as water or stock) are placed in the slow cooker. Some recipes call for pre-heated liquid. The cooker lid is put on and the cooker is switched on. Some cookers automatically switch from cooking to warming (maintaining the temperature at 71-74° C. [160-165° F.]) after a fixed time or after the internal temperature of the food, as determined by a probe, reaches a specified value. Thus a slow cooker allows a person to start dinner cooking in the morning before going to work and finish preparing the meal in the evening after work. But, one still must know how to cook, which spices to add, what quantities of spices to add in order to make a meal using a slow cooker.

A slow cooker is handy for making some kinds of recipes like soups and stews that require an elongated slow cooking period, but it has a limited repertoire. The long, moist cooking is not suitable for food items that are meant to remain crisp and fresh, as a slow cooker can leave food mushy by overcooking it. This process can also destroy nutrients particularly from vegetables due to enzyme action during cooking and due to heat degradation.

More recently, multi-cooker devices have become available, which although allowing for multiple cooking processes (e.g. baking or stewing), have many of the same drawbacks as slow cookers. Among the drawbacks is a lack of freshness or “a la minute” preparation of food ingredients. Such devices are not suited, for example, to stir-fried, poached, or steamed preparations, which require precise timing and precise exposure of ingredients to short heating durations, and/or exposure of different ingredients to different amounts or durations of heat (e.g. onions vs. carrots).

It would be desirable to have methods of using an automated meal preparation apparatus that would allow for cooking from whole ingredients and developing and exchanging recipes for such apparatuses.

### SUMMARY

Broadly speaking, the invention provides an apparatus, a system and a method of automatic meal preparation that allows for a “eating without having to cook” experience—cooking from whole ingredients in a way that is easy, cost-effective and healthy.

The automatic meal preparation apparatus allows for preparing different recipes from various cuisines by using spices that are supplied in removable cartridges. The automatic meal preparation apparatus is computer assisted for controlling the time of cooking, intensity of heat, amount of spices, combination of spices, timing when individual raw ingredients are added to the cooking vessel, etc.

One type of apparatus which can be beneficially used for the present method is disclosed in applicants' previously filed USPTO patent application Ser. No. 14/952,142 filed on Nov. 25, 2015, the contents of which are incorporated herein by reference.

With this system, a central database may be provided for storing and categorizing recipes, e.g. a portal that is specifically designed for storing and categorizing recipes. Such a portal may be accessible via the Internet. A user may be allowed to upload a recipe to the system from a computing device such as a tablet.

The recipe may be tested by preparing a meal in the Automatic Meal Preparation Apparatus (AMPA). The recipe testing process may be manual such that a person (tester) tests the recipe by preparing it with the Automatic Meal Preparation Apparatus. This may be used as the basis for “certification” of a recipe.

In such a process, a person (tester) tests the recipe by using the Automatic Meal Preparation Apparatus (AMPA) and then tastes the resultant meal. In order to be certified, the test may need to follow a given standard which may have criteria that needs to be satisfied before a recipe can be considered certified. Recipe testing may for example be done by designated recipe testers. Alternatively, recipes may be tested by a crowd, and only recipes achieving a certain level of popularity or appeal to the crowd may achieve certification. In one embodiment, a signature may be embedded in a recipe that it has been tested and certified. The signature may be encrypted so that it may not be altered or tampered with. In one embodiment of the invention the Automatic Meal Preparation Apparatus may check for the signature to ensure that the recipe is certified and will prepare a meal that will be up to standard.

The recipe may be made available for general download to the user base to use in the Automatic Meal Preparation Apparatus (AMPA). To facilitate searching and browsing for recipes, they may be categorized and/or tagged.

The recipe creation and recordation may be done using an app that executes on a mobile device like a tablet or a Smartphone. Alternatively, the recipe creation and recordation may be done using a web based portal. In both cases the creation and saving of the recipe may be a stepped process that guides the user to ensure that there are no missing steps. Such an app or portal may also provide functionality for converting to AMPA standard a recipe in regular (traditional) format.

Using the UI, a user can creates a new recipe and save it with an unique name. Saving recipes with a unique name may be required to avoid duplication and in assisting with the categorization of the recipes.

The user may select the number of servings (yield) that the recipe cooks; e.g. a meal for 1 person as opposed to a meal for 4 persons. The UI may provide the user with a drop down menu to select the number of persons.

The user may select the meat that is being used in the recipe e.g. chicken, beef, pork, lamb, fish etc.; the meat quantity e.g. 8 oz of beef or 2 lbs of fish; and the meat preparation instructions e.g. cut into cubes, or filleted and/or marinated in a sauce. A user interface may provide the user with a drop down menu to select the meat, the quantity and units of weight for the recipe, and different options for meat preparation, either in a list or a drop down menu.

The user may select the vegetables that are being used in the recipe, the vegetable quantities e.g. 4 oz of peas and 1 lb of potatoes, and the vegetable preparation instructions e.g. wash the peas and dice and wash the potatoes. A user interface may provide the user with a drop down menu to select the different vegetables to be used in the recipe, the vegetable quantities and preparation instructions.

The user may select the spices and their amounts being used in the recipe e.g. ⅓ teaspoon of salt and 6 whole black peppercorns, 1 tablespoon of Thai chili sauce, ¼ teaspoon of spicy red curry paste, 1 tablespoon of cooking wine, ½ teaspoon of garlic paste, ¼ teaspoon of ginger paste, etc.

The user may then select the cooking duration for each stage, e.g. cook the meat for 10 minutes then add the vegetables and cook for a further 15 minutes.

The user may then select the cooking temperature e.g. 350 F. A user interface may provide the user with a drop down menu to select the different cooking temperatures dependent on the type of meat and its quantity.

There may be optional guidelines with respect to temperature and time that depend on the type of meat and its quantity. This ensures that the user is not under-cooking or over-cooking the meat. Optionally a recipe may require preparing the meal at different temperatures for different durations. For example, cook the chicken at 350 F for 5 minutes, add vegetables and cook for a further 10 minutes a 250 F and then simmer at 150 F for a final 10 minutes.

There may be checks and balances for cooking time, cooking temperatures and spice quantities, etc. The cooking time and temperature may be dependent on the type of meat and its quantity. A user may be able to override these thresholds, and there may be warnings provided to the user if such thresholds are ignored.

A user may connect the automatic meal preparation apparatus to the Internet or other network e.g. a local area network (LAN). Connectivity with the internet may be via a wireless connection using Bluetooth, WiFi or other such technology, or via a hard wired LAN connection. It should be noted that the automatic meal preparation apparatus does not require Internet connection for its normal operations i.e. for meal preparation. The connectivity may only be required when new recipes are to be downloaded to the apparatus, or when a user wants to initiate the meal preparation process remotely, or when a software or firmware update is required.

A user may access the central database of recipes using the wireless connection. The automatic meal preparation apparatus may provide a user interface and means for interacting with the user interface e.g. a built in LCD screen and buttons to navigate the list of recipes.

In one embodiment a user may browse and select a recipe from the list of recipes. The user experience of picking the recipe may include but is not limited to browsing a set of photos that show the prepared meals, either from a mobile device where the companion app is installed, or website e.g. a recipe portal which may provide means for searching recipes that have been categorized and cataloged based on a number of parameters e.g. type of cuisine, calorie count, chef, meal type (breakfast, lunch, dinner, dessert etc.), and the like.

The user may be able to browse and select the recipes from anywhere, e.g. from the office, and may be able to remotely download these to the automatic meal preparation apparatus either in real time or with a schedule e.g. select recipes during the weekdays and download the selected recipes on the weekend. Similarly, the user may also be able to schedule the automatic meal preparation apparatus to start cooking a meal based on a selected recipe from a remote location e.g. while riding a bus on the way to home.

Recipes may available on a for-pay basis. Users may be required to create an account with the portal, and log in using the credentials of their individual account. There may optionally be means for users to create user accounts, get subscriptions for monthly recipes, pay for the accounts and subscriptions, or pay as you go methods for receiving recipes, gift, share, exchange, trade, swap, auction, etc.

The user may download a selected recipe directly into the automatic meal preparation apparatus. Alternatively, the recipe may be first downloaded to a mobile device e.g. a tablet, and the recipe may be subsequently transferred to the automatic meal preparation apparatus either initiated by a user or automatically when the mobile device is in the vicinity of the automatic meal preparation apparatus using a wireless technology like Bluetooth.

The downloaded recipe may be saved to the local database of recipes in the automatic meal preparation apparatus; and the newly downloaded and saved recipe becomes available for meal preparation, and a user can search locally for the recipe by name (e.g. Chilli Chicken), by cuisine type (e.g. Chinese), by calorie count (e.g. medium calorie meal), by ingredient type (e.g. chicken), by chef name (e.g. Bobby Flay) etc.

According to a first aspect of the invention, a method is provided for preparing a recipe with an automatic meal preparation apparatus. A selection is received of a recipe from a recipe database associated with the automatic meal preparation apparatus. It is checked that the selected recipe has been certified for the automatic meal preparation apparatus. In accordance with the recipe, a user is directed to add prepared raw ingredients to a raw ingredients compartment in the apparatus. Before, after or during these steps, it is checked that at least one spice/sauce cartridge needed for the recipe is in the apparatus. The apparatus then executes instructions of the recipe for:
selectively heating a heating element of the apparatus at pre-determined times;
selectively dispensing at least a portion of the raw ingredients by releasing them from the compartment into a cooking vessel in communication with the heating element at a pre-determined time;
selectively dispensing a pre-determined measure of the spice/sauce from the at least one spice/sauce cartridge by releasing it into the cooking vessel at a pre-determined time; and
stirring and cooking the ingredients and the spice/sauce in the vessel for a specified duration, in accordance with the recipe.

The recipe may be selected on the apparatus, or on a device other than the apparatus. The device may be in communication with the apparatus over a wireless network.

Preferably, the recipe is selectable by at least one of parameter including: category, author/chef, style, ingredient, ethnicity, yield, cooking time, complexity, calories, or dietary concern.

The recipe may be selected by picture or photograph.

The recipe may also include instructions for stirring speed or intensity, and instructions for ventilation or fan speed.

The user may be allowed to override at least one of the instructions of the recipe on the apparatus.

The recipe options that are selectable may be pre-filtered by availability of spice/sauce cartridges in the apparatus.

Checking the certification may include checking for an embedded signature associated with the recipe.

According to a second aspect of the invention, a method is provided for sharing a recipe for an automatic meal preparation apparatus. An uploaded recipe is received that includes instructions in a format for use in an automatic meal preparation apparatus. These include instructions for:
selectively heating a heating element of the apparatus at pre-determined times;
selectively dispensing a raw ingredient by releasing it from a raw ingredients compartment of the apparatus into a cooking vessel in communication with the heating element at a pre-determined time;
selectively dispensing a pre-determined measure of a spice/sauce from a spice/sauce cartridge by releasing it into the cooking vessel at a pre-determined time; and
stirring and cooking the ingredient and the spice/sauce in the vessel for a specified duration;

The recipe is certified. The recipe is then made available in a browsable or searchable database for a user of the automatic meal preparation apparatus. The user is allowed to download the recipe for carrying out the instructions on the user's automatic meal preparation apparatus.

The recipe may be further tagged or categorized by author/chef, style, ingredient, ethnicity, yield, cooking time, complexity, calories, or dietary concern.

A picture or photo of the prepared recipe may also be received with the recipe instructions. The picture or photo may be published with the recipe in the brows able or searchable database.

The method may also include checking what ingredients the user has on hand prior to allowing the user to download the recipe, and the recipe may be keyed to at least one ingredient the user has on hand.

The method may also include checking what spice/sauce cartridges the user has on hand prior to allowing the user to download the recipe, and the recipe may be keyed to at least one spice/sauce cartridge the user has on hand.

The user may also be allowed (or invited) to purchase a spice/sauce cartridge associated with a downloaded recipe.

Certifying the recipe may include associating an embedded signature associated with the recipe.

### BRIEF DESCRIPTION OF THE DRAWINGS

FIG. 1 is a flow diagram of an embodiment of a method of sharing recipes for an automatic meal preparation apparatus.

FIG. 2A is a perspective view of a preferred embodiment of the automatic meal preparation apparatus.

FIG. 2B is a view of a spice/sauce compartment for the automatic meal preparation apparatus shown in FIG. 2A.

FIG. 3 is a flow diagram of a method of entering a recipe.

FIG. 4 is a flow diagram of a method of selecting and downloading a recipe.

FIG. 5 is a flow diagram of a method of transferring a downloaded recipe from a device to a paired automatic meal preparation apparatus.

FIG. 6 is a flow diagram of a method of certifying a recipe.

FIG. 7 is a flow diagram of a recipe selection process governed by spice cartridge(s) on hand (or previously purchased).

FIG. 8 is a flow diagram of a payment process for rental or purchase of a recipe.

FIG. 9 is a flow diagram of a checking process prior to allowing a recipe to be downloaded.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, the embodiments described herein may be practiced without these specific details. In other instances, well-known methods, procedures and components have not been described in detail so as not to obscure the embodiments described herein.

Before embodiments of the hardware and software modules or flow charts are described in detail, it should be noted that the invention is not limited to any particular form or shape or software language described or implied in the figures and that a variety of alternative software languages may be used for implementation of the invention.

It should also be understood that many components and items are illustrated and described as if they were hardware elements, and vice versa. However, it will be understood that the intent is not to limit the form and physical architecture of programming or instructional components.

As will be appreciated by one skilled in the art, aspects of the present invention may be embodied as a system, method or computer program product. Accordingly, these aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, these aspects may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on the apparatus of the invention, or in combination with a mobile device or partly on the mobile device as a stand-alone software package; partly on the mobile device and partly on the apparatus of the invention or partly on the apparatus of the invention and partly on a remote server; or any combination thereof. The remote computer may be connected to the apparatus of the invention via the internet or may be connected to the mobile device through any type of network, including a local area network (LAN) or a wide area network (WAN), or the connection may be made to the internet through a mobile operator network (e.g. a cellular network).

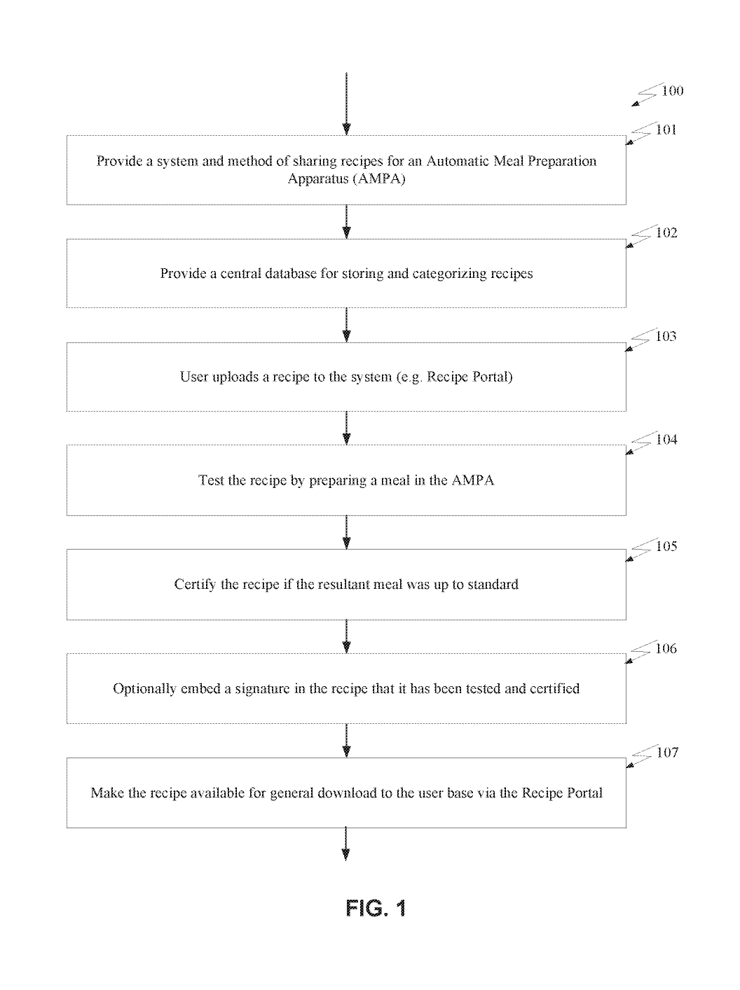

FIG. 1 shows an embodiment of a method of sharing recipes for an automatic meal preparation apparatus 100. A system and method of sharing recipes for an Automatic Meal Preparation Apparatus (AMPA) is provided 101. The AMPA is capable of preparing different recipes from various cuisines by using spices/sauces that are supplied in removable cartridges. The AMPA is computer assisted for controlling the time of cooking, intensity of heat, amount of spices, combination of spices, timing when individual raw ingredients are added to the cooking vessel etc.

One type of apparatus which can be beneficially used for the present method is disclosed in previously filed USPTO patent application Ser. No. 14/952,142 filed on Nov. 25, 2015 by the same applicants, the contents of which are incorporated herein by reference.

A central database is provided for storing and categorizing recipes 102. In one embodiment a portal may be provided that is specifically designed for storing and categorizing recipes.

A user uploads a recipe to the system 103. The portal may be accessible via the internet, and a user may use a computing device like a tablet to upload a recipe to the portal.

The recipe is tested by preparing a meal in the AMPA 104. In one embodiment the recipe testing process may be manual such that a person (tester) tests the recipe by using the Automatic Meal Preparation Apparatus (AMPA).

The recipe may be certified as being up to a certain standard 105. The recipe certification process may be manual such that a person (tester) tests the recipe by using the Automatic Meal Preparation Apparatus (AMPA) and then tastes the resultant meal. The certification process may follow a given standard which may have criteria that needs to be satisfied before a recipe can be considered certified.

Optionally, a signature may be embedded in the recipe that it has been tested and certified 106. The signature may be encrypted so that it may not be altered or tampered with. The AMPA may check for the signature to ensure that the recipe is certified and will prepare a meal that will be up to standard.

The recipe is made available for general download to the user base 107. In one embodiment the recipe may be categorized and put on the portal for the general public to download and use in the AMPA.

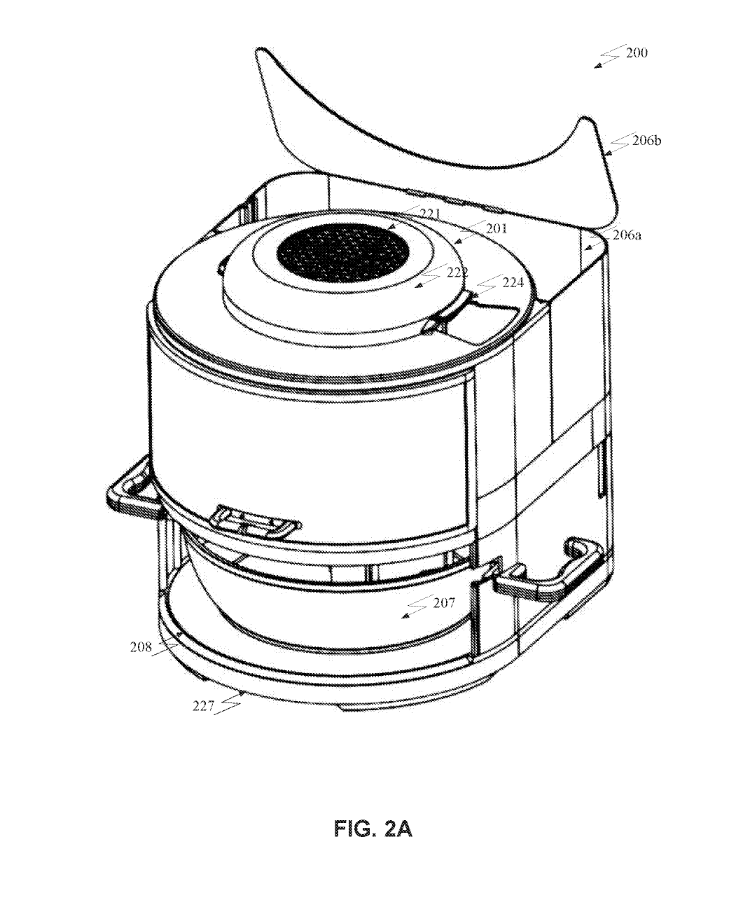

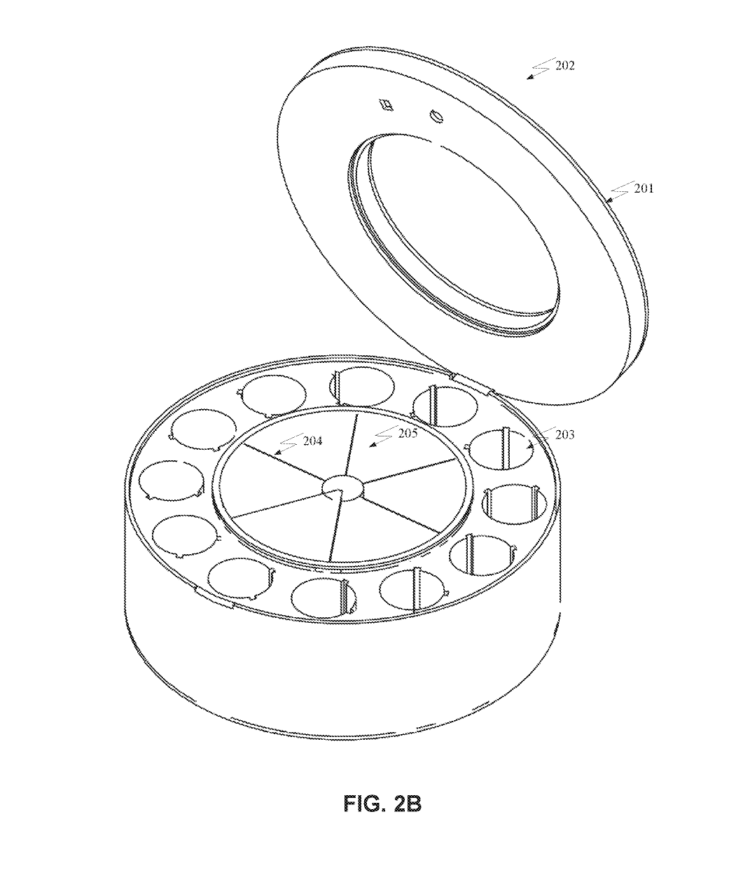

FIG. 2A displays an exemplary AMPA 200 which is capable of preparing different recipes from various cuisines. The apparatus 200 is computer assisted for providing a no hassles experience to the user when preparing a meal.

FIGS. 2A and 2B show one embodiment of the AMPA 200 and its various constituent components. FIG. 2B shows the spice rack 202 with lid 201 open. The lid 201 is openable and provides access to the spice rack 202, which provides the housing for the placement of the different spice cartridges 203 for dispensing spice/sauces into the cooking vessel 207.

As shown in FIG. 2B, the spice rack 202 is removable and provides space where several spice cartridges 203 can be removably placed. Each spice cartridge 203 many contain a different spice or sauce. A mechanical mechanism may be provided for rotating the spice rack 202 so that different spices can be dispensed into the cooking vessel 207. A spice recognition system for identifying the right spice before dispensing may also be provided.

As shown in FIG. 2B, the apparatus also has a raw ingredients placement compartment 204. The raw ingredients placement compartment 204 may be divided into multiple sub-compartments for placement of raw food before cooking. An opening 205 is provided in the raw ingredients placement compartment 204 so that the user is guided to place raw ingredients one at a time in each of the separate sub-compartments which are then selectively emptied into the cooking vessel 207 as the steps of the recipe are carried out.

In one embodiment the middle section of the automatic meal preparation apparatus 200 provides a space for the placement of a cooking vessel 207 where the meal is prepared. A stirring arm (not shown) is preferably provided for stirring the ingredients in the cooking vessel. The stirring arm is preferably actuated by a motor (not shown) in the bottom (base) section 208 of the apparatus.

In one embodiment, as shown in FIG. 2A, the apparatus has a water reservoir 206a with a lid 206b. The water reservoir is preferably in selective fluid communication with the cooking vessel. The recipe may include instructions for dispensing water into the cooking vessel, or for heating the water separately to provide steam to the cooking vessel.

(Note that certain embodiments may also include an oil reservoir for frying applications, not shown. Alternatively, oil may be included as a spice/sauce in one of the spice/sauce cartridges, not shown in this view.)

The apparatus preferably also includes a ventilation fan that is designed to keep the humidity level in the automatic meal preparation apparatus at the correct level. In addition, this fan keeps the internal temperature regulated for cooking particular types of meals.

Aspects of the ventilation system are also shown. Air enters the apparatus through vents through an intake around area 227. Air flows generally upward through the housing at a central column to exit through lid vent 221 in lid 222. The lid is openable through latch 224. A fan may be provided in the vented lid (not shown). This fan communicates with exterior vent 221. The electronics may be ventilated separately.

In one embodiment of the invention the cooking vessel 207 is heated using induction heating. The cooking vessel may be of a metallic material or another material that is induction-friendly.

The bottom section 208 houses various sub-components including the electronics for controlling the various functions of the automatic meal preparation apparatus (not shown) and induction coils (not shown) for inducing heat in the cooking vessel 207.

The AMPA may have a display screen e.g. an LCD screen that may be used for providing visual cues and a user interface for a user interacting with the AMPA. There may be one or more buttons or other input mechanisms using which a user may be able interact with the visual interface for example by pressing a down button scroll through the local database of recipes stored in the AMPA, or enter a WiFi password by pressing the buttons to cycle through a list of alphabets, digits and symbols, or receive visual alerts from the AMPA about the meal that is being prepared e.g. “Meal will be ready in 10 minutes”. The display screen may preferably be rectangular, black and white or color, and may use LCD (liquid crystal display), LED (light emitting diodes) or OLED (organic light emitting diodes) technology depending on the implementation. The display screen may be used for displaying images, icons, text and other visual clues to the user; and the invention is not limited to the examples cited here. A remote control with such controls and/or screens may also be provided.

Although in this disclosure we use the term “spice cartridge” to mean a cartridge that contains an individual spice, or a combination of spices, in fact the cartridges may contain either a spice, a combination of spices, a sauce, a paste or liquids like vinegar and other ingredients that may be used in cooking. Other examples include food seasonings, coloring, marinades, vinaigrettes, dressings, oils, and the like. Additionally the spice cartridge may contain ground spice that is dispensed as is, or a whole spice that is ground on an as need basis before being dispensed, or that is dispensed whole. Cartridges may also contain pastes, thick liquids or gels, or mayor any other forms of solutions or emulsions containing ingredients used in meal preparation.

The term spice may include but is not limited to culinary herbs, spices and/or any other food or drink additives of mostly botanical origin but may include minerals like salt, used for flavoring, seasoning or coloring. Examples of some spice cartridges include but are not limited to the following: salt, pepper, Thai chilli sauce, spicy red curry paste, cooking wine, soya sauce, garlic paste, ginger paste, granular sea salt, coarse ground black pepper, ground red paprika, oregano, sticks of cinnamon, whole cloves, whole black peppercorns etc. that are ground on demand, or dispensed from their respective cartridges whole.

The following is an exemplary categorization of different types of spice cartridges:
Ground: salt, pepper, red chillies,
Coarsely Ground: sea salt, black pepper, chilli flakes
Solids: whole black peppers, cinnamon sticks, bay leaf (solids may be dispensed as solids or as freshly ground on demand
Liquids: soya sauce, vinegar, aged olive oil,
Sauces/Thick Liquids: mustard, tomato sauce,
Pastes: garlic paste, ginger paste, wasabi, curry paste

Each spice cartridge may contain a unique code that may define its contents, its date of manufacture, its quantity, its brand, etc. In one embodiment this metadata about the spice cartridge may be saved on a server, and the AMPA acquires this metadata from the server when a spice cartridge is placed in the spice rack and the top lid of the AMPA is closed. The AMPA may have sensors or electronic sub-components that may scan or read the unique code from the individual spice cartridge.

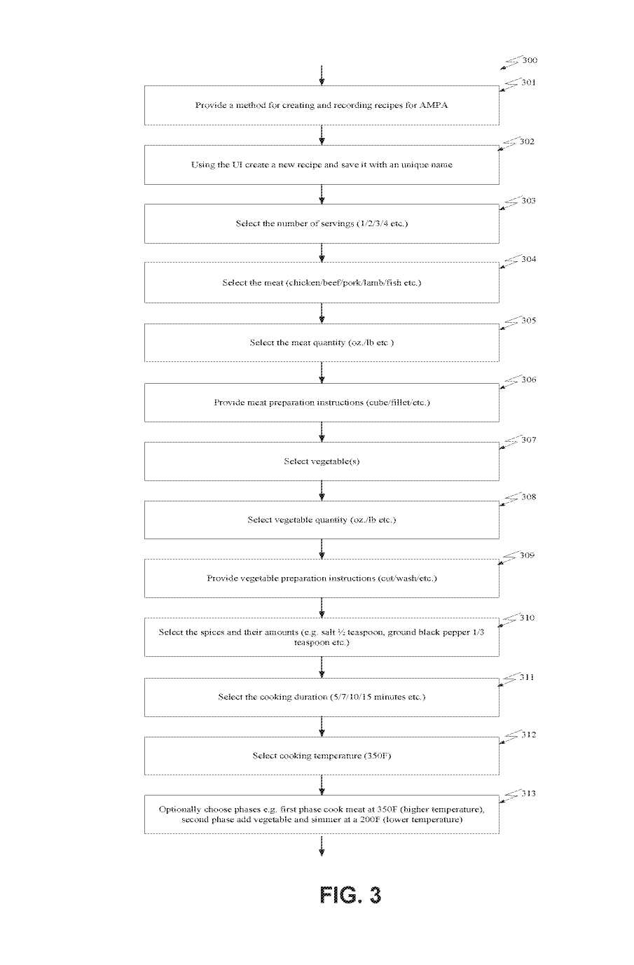

FIG. 3 shows one embodiment of a method of entering a recipe 300. A method is provided for creating and recording recipes for the AMPA 301. The recipe creation and recordation may be done using an app that may execute on a mobile device like a tablet or a Smartphone. In another embodiment the recipe creation and recordation may be done using a web based portal. In both cases the creation and saving of the recipe may be a stepped process that guides the user and ensure that there are no missing steps.

Using the UI, the user may create a new recipe and save it with an unique name 302. Saving recipes with a unique name may be required to avoid duplication and to assist with the categorization of the recipes.

The number of servings (1/2/3/4 etc.) may be selected 303. In one embodiment of the invention a user selects the number of servings that the recipe cooks; e.g. a meal for 1 person as opposed to a meal for 4 persons. The UI may provide the user with a drop down menu to select the number of persons.

A meat (chicken/beef/pork/lamb/fish etc.) may be selected 304. The UI may provide the user with a drop down menu to select the meat for the recipe.

The meat quantity may be selected (oz./lb etc.) 305, e.g. 8 oz of beef or 2 lbs of fish. The UI may provide the user with a drop down menu to select the quantity and units of weight.

Meat preparation instructions may be selected (cube/fillet/etc.) 306, e.g. should the meat be cut into cubes, or filleted and/or marinated in a sauce. The UI may provide the user with different options for meat preparation either in a list or a drop down menu.

The vegetable(s) may be selected 307. The UI may provide the user with a drop down menu to select the different vegetables to be used in the recipe.

The vegetable quantity may be selected (oz./lb etc.) 308, e.g. 4 oz of peas and 1 lb of potatoes.

The vegetable preparation instructions may be selected (cut/dice/wash/etc.) 309, e.g. wash the peas and dice and wash the potatoes. The UI may provide the user with a drop down menu to select the vegetable preparation instructions.

The spices and their amounts may be selected 310, e.g. ⅓ teaspoon of salt and 6 whole black peppers, 1 tablespoon of Thai chilli sauce, ¼ teaspoon of spicy red curry paste and 1 tablespoon of cooking wine, ½ teaspoon of garlic paste, ¼ teaspoon of ginger paste etc.

The cooking duration may be selected (5/7/10/15 minutes etc.) 311, e.g. cook the meat for 10 minutes then add the vegetables and cook for a further 15 minutes.

The cooking temperature may be selected 312, e.g. 350 F. The UI may provide the user with a drop down menu to select the different cooking temperatures dependent on the type of meat and its quantity.

There may be optional guidelines in terms of temperature and time that depend on the type of meat and its quantity. This ensures that the user is not under-cooking or over-cooking the meat. Stirring speed, duration, and intensity may also be selected, as well as, ventilation options (e.g. % ventilation or fan speed).

Optionally the user may choose phases e.g. first phase cook meat at 350F (higher temperature), second phase add vegetable and simmer at a 200 F (lower temperature) 313. The recipe may require cooking the meal at different temperatures for different durations. For example, cook the chicken at 350 F for 5 minutes, add vegetables and cook for a further 10 minutes a 250 F and then simmer at 150 F for a final 10 minutes.

There may be checks and balances for cooking time, cooking temperatures, stirring, ventilation, and spice quantities, etc. The cooking time and temperature may be dependent on the type of meat and its quantity. A user may be able to override these thresholds, and there may be warnings provided to the user if such thresholds are ignored. For example, specific ventilation thresholds may be triggered at certain cooking temperatures.

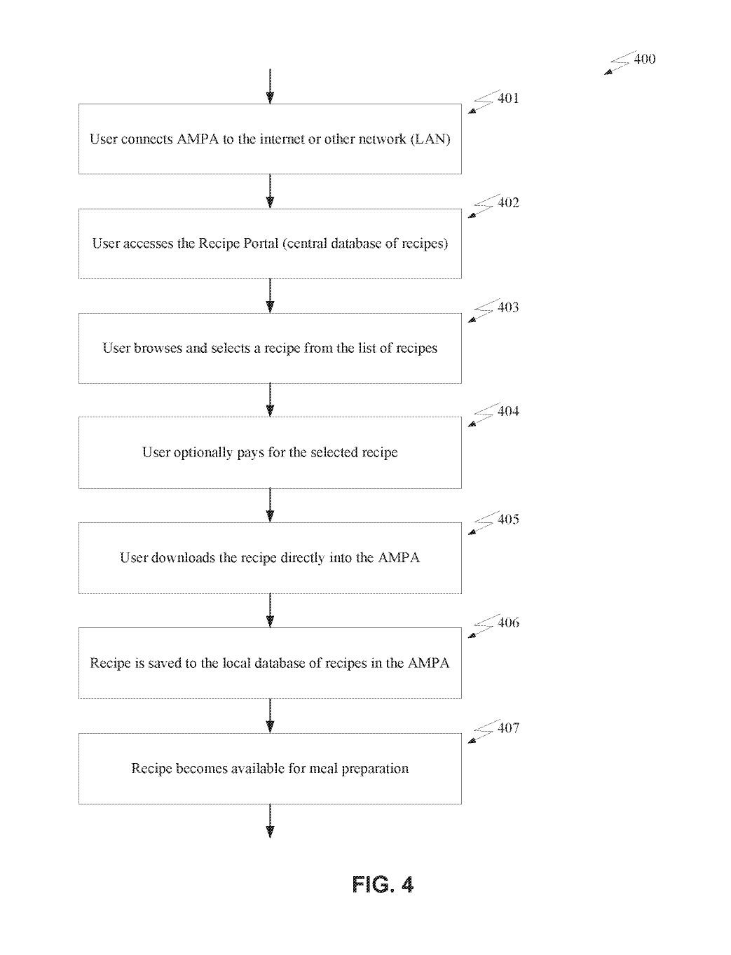

FIG. 4 shows one embodiment of the method of selecting and downloading a recipe 400. The user connects the AMPA to the Internet or other network (LAN) 401. Connectivity with the internet may be via a wireless connection using Bluetooth, WiFi or other such technology, or via a hard wired LAN connection.

It should be noted that the automatic meal preparation apparatus does not require Internet connection for its normal operations i.e. for meal preparation. The connectivity may only be required when new recipes are to be downloaded, or when a user wants to initiate the meal preparation process remotely or when a software or firmware update is required.

The user accesses the central database of recipes 402, using the wireless connection. The automatic meal preparation apparatus may provide a user interface and means for interacting with the user interface e.g. a built in LCD screen and buttons to navigate the list of recipes.

The user browses and selects a recipe from the list of recipes 403. The user experience of picking the recipe may include but is not limited to browsing a set of photos that show the prepared meals, either from a mobile device where the companion app is installed, or website e.g. a recipe portal which may provide means for searching recipes that have been categorized and cataloged based on a number of parameters e.g. type of cuisine, calorie count, chef, meal type (breakfast, lunch, dinner, dessert etc.), and the like.

The user may be able to browse and select the recipes from anywhere e.g. from the office and may be able to remotely download these to the automatic meal preparation apparatus either in real time or with a schedule e.g. select recipes during the weekdays and download the selected recipes on the weekend. Similarly, the user may also be able to schedule the automatic meal preparation apparatus to start cooking a meal based on a selected recipe from a remote location e.g. while riding a bus on the way to home.

The user may optionally pay for the selected recipe 404. A Recipe Portal may be provided for the convenience of users, and the users may be required to create an account, and log in using the credentials of their individual account. There may optionally be means for users to create user accounts, get subscriptions for monthly recipes, pay for the accounts and subscriptions, or pay as you go methods for receiving recipes, gift, share, exchange, trade, swap, auction, etc.

The user may download the recipe directly into the AMPA 405. Alternatively, the recipe may be first downloaded to a mobile device e.g. a tablet from where the recipe may be transferred to the automatic meal preparation apparatus. This may be either initiated by the user or may occur automatically when the mobile device is in the vicinity of the AMPA using a wireless technology like Bluetooth.

The recipe is then saved to the local database of recipes in the AMPA 406.

The recipe at this point becomes available for meal preparation 407. In one embodiment the user can search locally for the recipe by name (e.g. Chilli Chicken), by cuisine type (e.g. Chinese), by calorie count (e.g. medium calorie meal), by ingredient type (e.g. chicken), by chef name (e.g. Bobby Flay) etc.

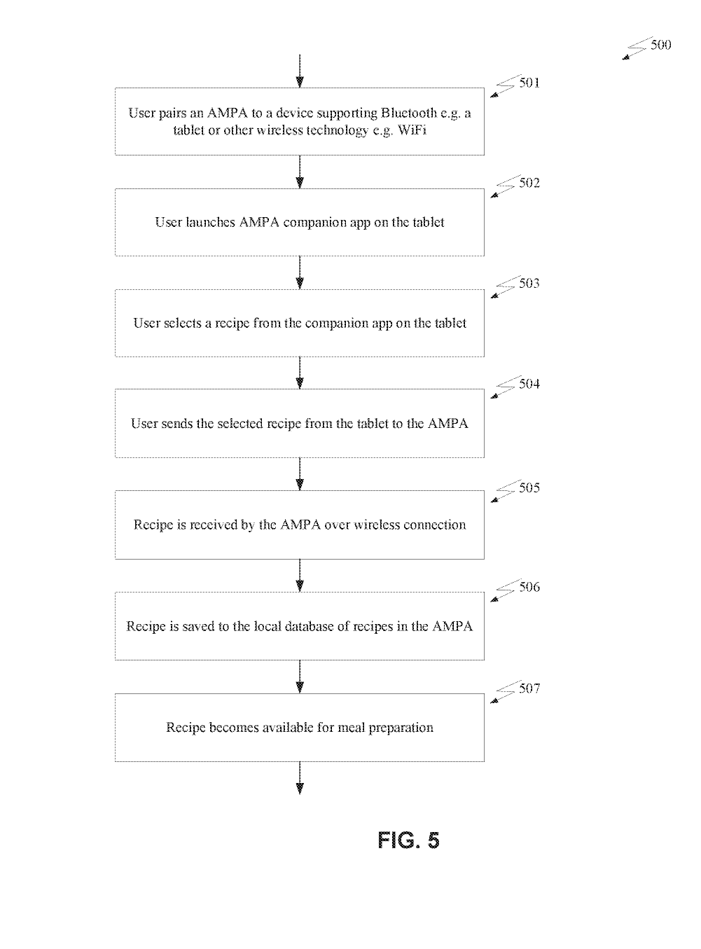

FIG. 5 shows one embodiment of the method of transferring a recipe from a device to AMPA 500. The user pairs an AMPA to a device supporting Bluetooth e.g. a tablet or other wireless technology e.g. WiFi 501.

In one embodiment a Bluetooth connection may be established between the automatic meal preparation apparatus and the tablet. Bluetooth is a technology standard for exchanging data over short distances (using short-wavelength radio transmissions) from fixed and mobile devices, creating personal area networks (PANs) with high levels of security. Bluetooth can connect several devices, overcoming problems of synchronization. Bluetooth is a standard wire-replacement communications protocol primarily designed for low power consumption, with a short range. Because the devices use a radio (broadcast) communications system, they do not have to be in visual line of sight of each other.

In one embodiment Bluetooth Low Energy (Bluetooth LE) may be used as a wireless technology. Bluetooth LE is a wireless personal area network technology designed and marketed as Bluetooth Smart by the Bluetooth Special Interest Group. Compared to Classic Bluetooth, Bluetooth Smart is intended for considerably reduced power consumption and lower cost while maintaining a similar communication range. Mobile operating systems including iOS, Android, Windows Phone and BlackBerry, as well as OS X, Linux, and Windows 8, natively support Bluetooth Smart. Bluetooth Smart uses the same 2.4 GHz radio frequencies as Classic Bluetooth, which allows dual-mode devices to share a single radio antenna.

A master Bluetooth device can communicate with a maximum of seven devices in a piconet (an ad-hoc computer network using Bluetooth technology), though not all devices reach this maximum. The devices can switch roles, by agreement, and the slave can become the master.

At any given time, data can be transferred between the master and one other device (except for the less-used broadcast mode). The master chooses which slave device to address; typically, it switches rapidly from one device to another in a round-robin fashion.

Any Bluetooth device in discoverable mode will transmit the following information on demand:
Device name
Device class
List of services
Technical information (for example: device features, manufacturer, Bluetooth specification used, clock offset)

Any device may perform an inquiry to find other devices to connect to, and any device can be configured to respond to such inquiries. However, if the device trying to connect knows the address of the device, it always responds to direct connection requests and transmits the information shown in the list above if requested. Use of a device's services may require pairing or acceptance by its owner, but the connection itself can be initiated by any device and held until it goes out of range. Some devices can be connected to only one device at a time, and connecting to them prevents them from connecting to other devices and appearing in inquiries until they disconnect from the other device.

Every device has a unique 48-bit address. However, these addresses are generally not shown in inquiries. Instead, friendly Bluetooth names are used, which can be set by the user. This name appears when another user scans for devices and in lists of paired devices. By default most phones have the Bluetooth name set to the manufacturer and model of the phone.

While a preferred embodiment of the invention uses Bluetooth LE, in other embodiments wireless technologies like Bluetooth Classic, Near Field Communications (NFC), InfraRed (IR), WiFi Direct and the like may be used instead.

The user launches an AMPA companion app on the tablet 502. In one embodiment of the invention the user launches automatic meal preparation apparatus companion app on the tablet.

The companion app may be installed by the user on a mobile/portable device e.g. a Smartphone or a tablet. The app interface may preferably provide an interface for connecting to the AMPA, connecting to the Recipe Portal and searching, browsing and downloading different recipes. The app may also preferably be able to send the downloaded recipe(s) to the AMPA and start the meal preparation process remotely.

In one embodiment the companion app for the AMPA may be downloaded from an AppStore. Devices where such an app can be advantageously installed may include but not limited to an iPhone, iPad, Smartphones, Android phones, personal computers e.g. laptops, tablet computers, touch-screen computers running any number of different operating systems e.g. Android, MS Windows, Apple iOS, Linux, Ubuntu, etc.

The user selects a recipe from the companion app on the tablet 503.

The user sends the selected recipe from the tablet to the AMPA 504. The user may send the recipe by selecting a recipe and then clicking a button “Send to AMPA”, or by performing a gesture on a touchscreen of the tablet e.g. flicking the selected recipe.

The recipe is received by the AMPA over the wireless connection 505, e.g. a Bluetooth connection or a WiFi connection etc.

The recipe is saved to the local database of recipes in the AMPA 506. The recipe may be optionally categorized based on the cuisine type, or categorized based on the ingredients, or categorized based on the calories e.g. a low calorie meal, or added alphabetically or added under a chef name etc.

The recipe becomes available for meal preparation 507. A user can search for the recipe by name (e.g. goat curry), by cuisine type (e.g. curry), by calorie count (e.g. low calorie meal), by ingredient type (e.g. goat meat), by chef name (e.g. Cat Cora) etc.

Another embodiment may use WiFi to connect to the AMPA to the mobile device (e.g. a Smartphone or a tablet) of a user. In such an embodiment of the invention upon a first power up and successful connection to a WiFi network, the automatic meal preparation apparatus sends a ping to a central server with its public and private IP addresses and hardware identification e.g. a MAC address or other unique hardware identification. The central server is accessible over the internet and creates a new account for the said automatic meal preparation apparatus and provides the user with a user interface to enter a user name and a password to register the apparatus uniquely. Once the user has been able to enter the user name and password, the user is able to connect to the said automatic meal preparation apparatus via the internet using a browser and typing the URL for the portal e.g. www.kitchenmate.com and providing the log in credentials (user name and password). This way the user is now able to connect to his automatic meal preparation apparatus from anywhere using just a connected device with a browser e.g. a tablet with a browser. Once a user is able to connect to his automatic meal preparation apparatus, the user is able to download recipes to it, update its software or firmware, and initiate a meal preparation process either immediately or with a delay using a schedule.

The user may be able to control the AMPA through a local network without a companion app, by using a web browser on a connected device. For example, the AMPA may create an HTTP server on the local WiFi network. Upon a successful registration the public and private IP addresses along with the MAC address of the automatic meal preparation apparatus are stored and published to the central server. A user can connect to his unique automatic meal preparation apparatus from the portal e.g. www.kitchenmate.com, the central server then is able to issue commands and queries to the said automatic meal preparation apparatus using the public IP address over HTTP. In case the public IP address happens to be behind a firewall, a connection can still be made using the local network IP address and using technologies like Ajax to control it.

Thus a user can gain remote access to the his automatic meal preparation apparatus by visiting the central web application e.g. www.kitchenmate.com where queries and commands can be sent to the said automatic meal preparation apparatus connected on the same public IP address.

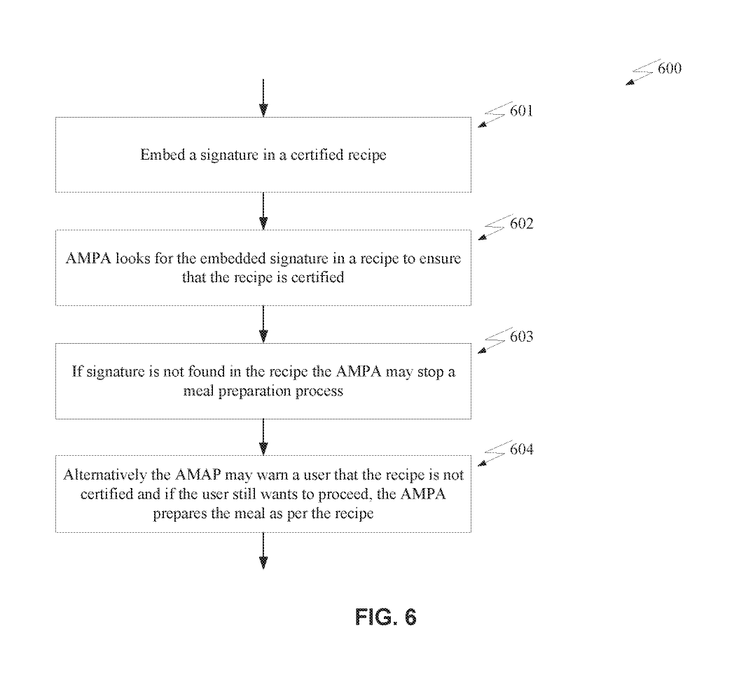

FIG. 6 shows one embodiment of a method of certifying a recipe 600. A signature may be embedded in a certified recipe 601 if the recipe passes the test and is being certified.

The AMPA looks for the embedded signature in a recipe to ensure that the recipe is certified 602.

If the signature is not found in the recipe the AMPA may stop the meal preparation process 603. Optionally, a warning may be displayed to the user. There may be an auditory warning played to the user via the speaker built into the automatic meal preparation apparatus.

Alternatively the AMPA may warn a user that the recipe is not certified and if the user still wants to proceed, the AMPA prepares the meal as per the recipe 604.

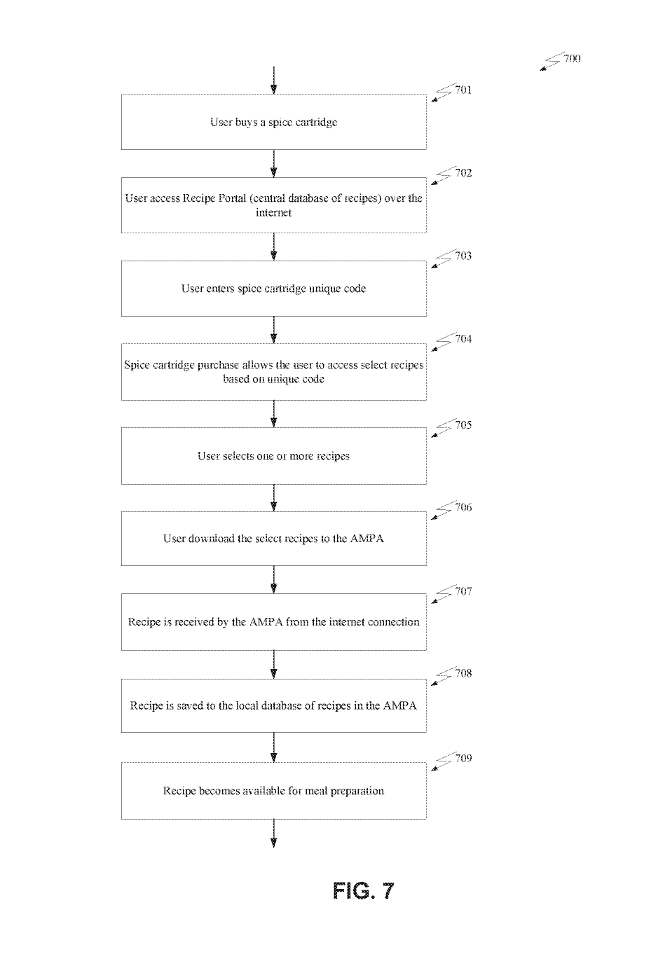

FIG. 7 shows one embodiment of a recipe selection process governed by spice cartridge(s) on hand (or previously purchased) 700. The user buys a spice cartridge 701. For example, the spice cartridge may be purchased at a retail location like a grocery store or may be purchased online.

The user accesses central database of recipes over the Internet 702, e.g. a recipe portal, a recipe search engine, a recipe sharing social network or the like.

The user may enter the spice cartridge unique code 703 into the interface of the portal. Each spice cartridge may have a code that identifies it uniquely. Such unique code in addition to providing the spice identification, may also provide details of what kind of spice or sauce is contained in the cartridge, where the spice cartridge was purchased from, when the cartridge was manufactured, if there is an expiry date of the contents of the cartridge when does it expire, what free or paid privileges may be associated with that particular spice cartridge for example how may free recipes or free instances of a recipe can be downloaded from the recipe portal etc.

In another embodiment the unique code of a spice cartridge may be directly read by the AMPA when the top lid of the apparatus is closed. Such automatic unique code reading may include steps like scanning the unique spice cartridge code or ID, and if the details associated with the unique code are not available locally on the AMPA acquiring the same from the recipe portal or the like by connected to the internet to access such a resource. The list of recipes may be automatically filtered so that they include only recipes that can be prepared with the spice cartridge whose unique code was scanned earlier.

Spice cartridge purchase may allow the user to access select recipes based on unique code 704. The spice cartridge purchase may allow the user to access select recipes based on the unique code of the spice cartridge and the recipes that can be prepared using that spice.

The user may select one or more recipes 705 that are available as a result of the purchase of the spice cartridge.

The user downloads the selected recipes to the AMPA 706.

The recipe is received by the AMPA from the internet connection 707.

The recipe is saved to the local database of recipes in the AMPA 708. When saving the recipe to the local database, all metadata associated with the unique code may also be saved to the local database in the AMPA for easy future reference.

The recipe becomes available for meal preparation 709.

There may be variations with different combinations and permutations of payments and recipes that can be downloaded. For example a user may pay $5 to download 10 recipes that can each be prepared 5 times, or for the same $5 may download 5 recipes that can be prepared 10 times each or other such combinations.

Some recipes may be worth more than others e.g. new recipes may be more expensive, while older ones may be cheaper, or simple recipes may be cheaper while more complex ones may be more expensive. Recipes by renowned chefs or sponsors may be more expensive.

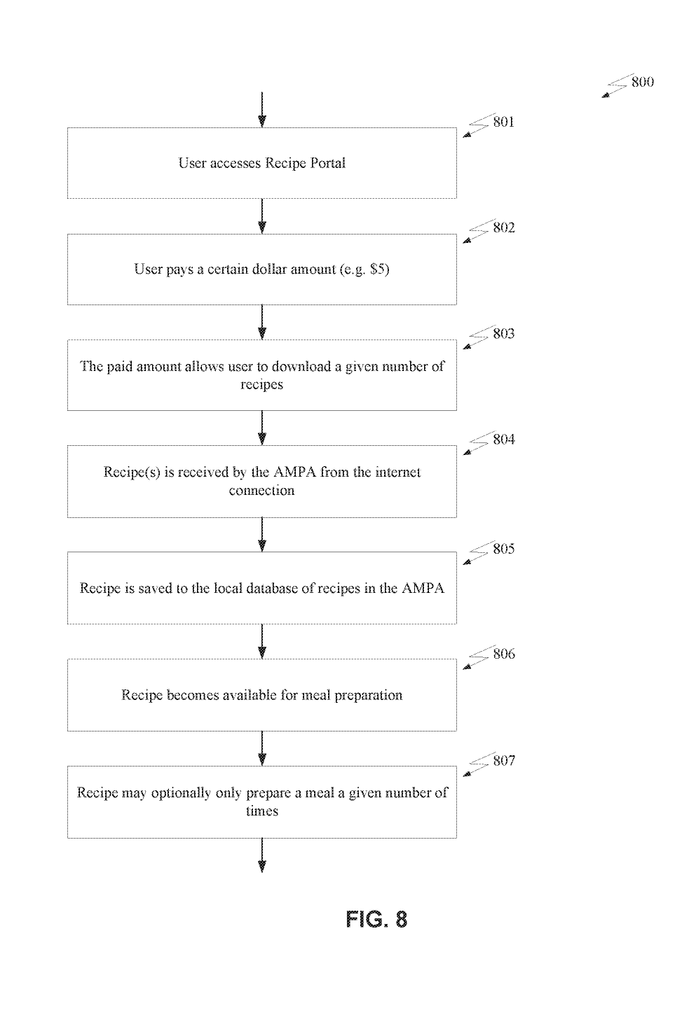

FIG. 8 shows one embodiment of a payment process 800. The user accesses the Recipe Portal 801. The user may access the recipe Portal via the internet using the companion app or directly from the automatic meal preparation apparatus.

The user may pay a certain dollar amount 802, e.g. $5 using a credit card or a gift card or similar mechanism used for online purchasing e.g. PayPal.

The paid amount may allow the user to download a given number of recipes 803.

The recipe is received by the AMPA from the internet connection 804.

The recipe is saved to the local database of recipes in the AMPA 805.

The recipe becomes available for meal preparation 806.

The recipe may optionally only remain on the device available to prepare a meal a given number of times 807. For example, a Thai Chicken recipe may be used 10 times only and may require the purchase of additional instances after the initial 10 instances have been used.

In another embodiment the user may be provided with the ability to gift or share unused or extra instances of a meal preparation of a recipe to friends or family. There may means for swapping meal preparation instances where a first user may swap their extra instances of a first recipe with a second user for instances of a second recipe. The Recipe Portal may provide a means for sharing, trading, swapping, gifting of recipes or instance of recipes.

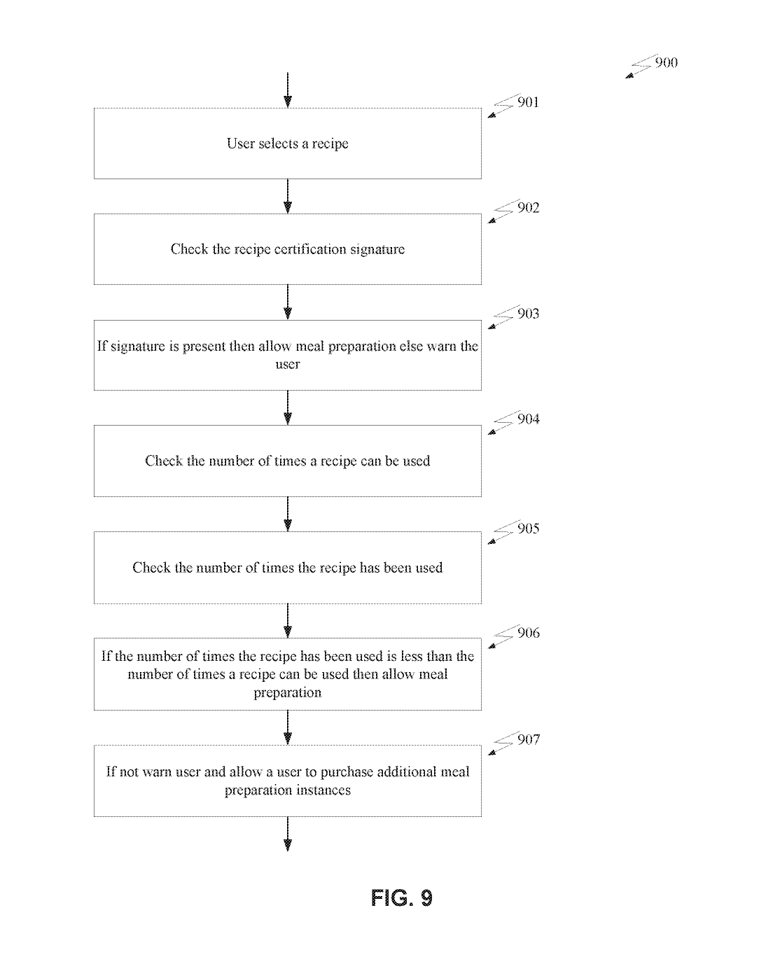

FIG. 9 shows one embodiment of a rental or purchase process 900. The user selects a recipe 901 either directly on an automatic meal preparation apparatus or selects it on an app that is installed on a connected device like a Smartphone.

The recipe certification signature is checked 902. The signature may have been embedded in the recipe at the time of the testing and certification given that the recipe met the certification criteria.

If a signature is present, then meal preparation is allowed or a warning is sent to the user 903. If there are no signatures found in the recipe then the apparatus or the companion app or both may warn the user that the recipe is not certified. The user may opt to ignore the warning and proceed with the preparation of the meal.

The system may check the number of times a recipe can be used 904. The system may also check if there is a time limit, or a number of times limit on the recipee.g. user paid $2.00 for the recipe to be able to use it 10 times and there is a 12 month time limit during which these 10 instances must be used.

The system may check the number of times the recipe has been used 905. There may be a counter in the AMPA or the app that keeps a track of the number of times a recipe has been used. The counter may write its increment number in the signature of the recipe; thus at the time of checking for a signature it can be simultaneously checked how many times the recipe can be used and how many times the recipe has been used.

If the number of times the recipe has been used is less than the number of times a recipe can be used then meal preparation is allowed to proceed 906.

If the number exceeds the permitted uses, the system may warn the user and allow (or invite) the user to purchase additional meal preparation instances 907.

The automatic meal preparation apparatus is capable of preparing different recipes from various cuisines by using spices that are supplied in removable cartridges. The automatic meal preparation apparatus is computer assisted for controlling the time of cooking, intensity of heat, amount of spices, combination of spices, timing when individual raw ingredients are added to the cooking vessel etc.

In one embodiment the apparatus of the invention may be able to interact with an app installed on a device. Such devices may include but are not limited to a mobile device for example a Smartphone, tablet, personal data assistant (PDA), game device, e-reader, a personal computer, a server, a laptop, a tablet computer, network appliance, set-top box, SmartTV, embedded device, computer expansion module, any appliances having internet or wireless connectivity.

In one embodiment the app may be launched on a connected device. Devices that can benefit from the system of the invention may include but are not limited to a mobile device for example a Smartphone, tablet, personal data assistant (PDA), game device, e-reader, a personal computer, a server, a laptop, a tablet computer, network appliance, set-top box, SmartTV, embedded device, computer expansion module, any appliances having internet or wireless connectivity.

In one embodiment a Bluetooth connection may be established between the AMPA and the connected device e.g. a tablet. The Bluetooth connection request may be initiated by a user. Alternatively, the Bluetooth connection request may be initiated by the app when the app is launched.

A user may be able to set timer so that the meal can be prepared at a later time. For example prepare the meal in 2 hours or prepare the meal for 6 μm in the evening.

Once the user has executed the steps necessary for the chosen recipe, the meal preparation process may automatically start.

It should be understood that although the term application has been used as an example in this disclosure but in essence the term may also imply to any other piece of software code where functional elements of the invention are incorporated. The software application can be implemented in a standalone configuration or in combination with other software programs and is not limited to any particular operating system or programming paradigm described here.

Several exemplary embodiments/implementations of the invention have been included in this disclosure. The application is not limited to the cited examples.

The intent of the application is to cover all practical combinations and permutations of the above, including those not listed here. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of preparing a recipe with an automatic meal preparation apparatus, comprising:
receiving a selection of a recipe from a recipe database associated with the automatic meal preparation apparatus;
checking that the selected recipe has been certified for the automatic meal preparation apparatus;
in accordance with the recipe, directing a user to add prepared raw ingredients to a raw ingredients compartment in the apparatus; and
checking that at least one spice/sauce cartridge needed for the recipe is in the apparatus;
wherein the apparatus then executes instructions of the recipe for:
selectively heating a heating element of the apparatus at pre-determined times;
selectively dispensing at least a portion of the raw ingredients by releasing them from the compartment into a cooking vessel in communication with the heating element at a pre-determined time;
selectively dispensing a pre-determined measure of the spice/sauce from the at least one spice/sauce cartridge by releasing it into the cooking vessel at a pre-determined time; and
stirring and cooking the ingredients and the spice/sauce in the vessel for a specified duration, in accordance with the recipe.

2. The method of claim 1, wherein the recipe is selected on the apparatus.

3. The method of claim 1, wherein the recipe is selected on a device other than the apparatus.

4. The method of claim 3, wherein the device is a device in communication with the apparatus over a wireless network.

5. The method of claim 1, wherein the recipe is selectable by at least one of category, author/chef, style, ingredient, ethnicity, yield, cooking time, complexity, calories, or dietary concern.

6. The method of claim 1, wherein the recipe is selected by picture or photograph.

7. The method of claim 1, wherein the recipe includes instructions for stirring speed or intensity.

8. The method of claim 1, wherein the recipe includes instructions for ventilation or fan speed.

9. The method of claim 1, further comprising allowing the user to override at least one of the instructions of the recipe on the apparatus.

10. The method of claim 1, wherein the recipe options that are selectable are pre-filtered by availability of spice/sauce cartridges in the apparatus.

11. The method of claim 1, wherein checking the certification includes checking for an embedded signature associated with the recipe.

12. A method of sharing a recipe for an automatic meal preparation apparatus, comprising:
receiving an uploaded recipe that includes instructions in a format for use in an automatic meal preparation apparatus, including instructions for:
selectively heating a heating element of the apparatus at pre-determined times;
selectively dispensing a raw ingredient by releasing it from a raw ingredients compartment of the apparatus into a cooking vessel in communication with the heating element at a pre-determined time;
selectively dispensing a pre-determined measure of a spice/sauce from a spice/sauce cartridge by releasing it into the cooking vessel at a pre-determined time; and
stirring and cooking the ingredient and the spice/sauce in the vessel for a specified duration;
certifying the recipe; and
making the recipe available in a browsable or searchable database for a user of the automatic meal preparation apparatus; and
allowing the user to download the recipe for carrying out the instructions on the user's automatic meal preparation apparatus.

13. The method of claim 12, further comprising tagging or categorizing the recipe by author/chef, style, ingredient, ethnicity, yield, cooking time, complexity, calories, or dietary concern.

14. The method of claim 12, further comprising receiving a picture or photo of the prepared recipe with the recipe instructions, and publishing the picture or photo with the recipe in the browsable or searchable database.

15. The method of claim 12, further comprising checking what ingredients the user has on hand prior to allowing the user to download the recipe, wherein the recipe is keyed to at least one ingredient the user has on hand.

16. The method of claim 12, further comprising checking what spice/sauce cartridges the user has on hand prior to allowing the user to download the recipe, wherein the recipe is keyed to at least one spice/sauce cartridge the user has on hand.

17. The method of claim 16, further comprising allowing the user to purchase a spice/sauce cartridge associated with a downloaded recipe.

18. The method of claim 12, wherein certifying the recipe includes associating an embedded signature associated with the recipe.
